(19) United States
(12) Patent Application Publication
(10) Pub. No.: US 2014/0333203 A1
(43) Pub. Date: Nov. 13, 2014

(54) RED EMITTING PHOSPHOR FOR PLASMA DISPLAY PANELS AND GAS DISCHARGE LAMPS

(71) Applicant: KONINKLIJKE PHILIPS N.V., EINDHOVEN (NL)

(72) Inventors: Georg Greuel, Eindhoven (NL); Thomas Juestel, Aachen (DE); Helga Bettentrup, Steinfurt (DE); Benjamin Herden, Steinfurt (DE); David Enseling, Steinfurt (DE)

(21) Appl. No.: 14/364,849

(22) PCT Filed: Dec. 4, 2012
(86) PCT No.: PCT/IB2012/056942

§ 371 Date: Jun. 12, 2014

Related U.S. Application Data
(60) Provisional application No. 61/569,315, filed on Dec. 12, 2011.

(51) Int. Cl. H01J 61/52; C09K 11/77; H01J 61/44; G01J 1/42; H01J 17/49; H01J 17/28

(52) U.S. Cl. CPC H01J 61/52; H01J 17/49; H01J 17/28; H01J 61/44; G01J 1/42; C09K 11/7709; C09K 11/7712; C09K 11/7706; C09K 2211/182; C09K 2211/183
USPC 315/117; 313/486; 356/218; 252/301.4 S; 252/301.4 P

(57) ABSTRACT

The invention provides a lighting unit (100) comprising (1) a vacuum ultraviolet (VUV) radiation based source of radiation (10) configured to generate VUV radiation (11), and (2) a luminescent material (20) configured to convert at least part of the VUV radiation into visible luminescent material light (21), wherein the luminescent material comprises a trivalent praseodymium containing material selected from the group consisting of (Zr_{1-x-y}HfₓPr_{y})(Si_{1-y}P_{y})0₄, (Zr_{1-x-y}HfₓPr_{y})₃((P_{1-3/4y}S_{3/4y})0₄)₄, and (Zr_{1-x-y}HₓPr_{y})₃((B_{1-3/4y}X_{3/4y}))O₃)₄, with x in the range of 0.0-1.0 and y being larger than 0 and being equal to or smaller than 0.15.

### FIELD OF THE INVENTION

The invention relates to a lighting unit comprising (1) a vacuum ultraviolet (VUV) radiation based source of radiation configured to generate VUV radiation and (2) a luminescent material configured to convert at least part of the VUV radiation into visible luminescent material light. The invention also relates to the use of said luminescent material for different applications, as well as to the luminescent material per se.

### BACKGROUND OF THE INVENTION

Luminescent materials (“phosphors”) which efficiently luminesce upon vacuum ultraviolet (VUV) excitation, so-called VUV phosphors or VUV luminescent materials, are applied in plasma display panels and Xe excimer discharge lamps.

The red phosphor used in many plasma display panels is (Y,Gd)BO₃:Eu, because this phosphor has a higher luminous efficacy when excited by VUV radiation than other red-emitting phosphors. Considerable disadvantages of this phosphor are on the one hand the color point, with x=0.643 and y=0.357, which is too orange for video applications, and on the other hand the comparatively long decay time of τ_{1/10}=9 ms. U.S. Pat. No. 5,136,207 describes, for example, a plasma picture screen with (Y,Gd)BO₃:Eu as the red-emitting phosphor. The orange color point of (Y,Gd)BO₃:Eu leads to a reduced color space in plasma picture display panels in comparison with cathode ray tubes in which Y₂O₂S:Eu is used as the red phosphor. The latter has a color point of x=0.659 and y=0.332.

### SUMMARY OF THE INVENTION

Since the 1990ties, the application of dielectric barrier (DB) noble gas (excimer) discharge is regarded as an alternative discharge concept for the development of UV emitting radiation sources. The Xe excimer discharge for instance, emits mainly 172 nm radiation. DB driven quartz lamps comprising Xe as a filling gas show a wall plug efficiency of more than 30%. Other emission wavelengths were achieved by using a XeBr* (282 nm), XeCl (308 nm), or KrCl* (222 nm) excimers, however, this may go at the cost of discharge efficiency (see also below).

As indicated above, luminescent materials which efficiently luminesce upon vacuum ultraviolet (VUV) excitation are for instance applied in plasma display panels and Xe excimer discharge lamps. To achieve a full color RGB panel with a large color gamut and high efficiency or a light source with a high color rendering index (CRI) and a high efficiency, red line emission between 600 and 630 nm is required. Therefore, most of these red emitting phosphors used in a trichromatic phosphor blends for lamps, or for the red pixels in emissive displays, rely on Eu³⁺ as activator, since it's a photochemical stable ion with an energy level diagram pointing to emission spectra with a high lumen equivalent. Examples of presently applied red-emitting VUV phosphors for the conversion of Xe excimer radiation in discharge lamps or plasma display panels are displayed in the table below:

| | Decay time (ms) | Peak emission | Colour point |
|---|---|---|---|
| Phosphor | τ_{1/e} | at [nm] | x, y |
| (Y, Gd)₂O₃: Eu | 1.0 | 611 | 0.63, 0.35 |
| (Y, Gd)BO₃: Eu | 3.5 | 595 | 0.64, 0.36 |
| (Y, Gd)(V, P)O₄: Eu | 1.5 | 620 | 0.65, 0.34 |
| Y₄Al₂O₉: Eu | 1.0 | 612 | 0.67, 0.32 |

These presently applied VUV emitting materials for for instance Xe, Ne, or Xe/Ne excimer discharges still have a couple of drawbacks, as e.g. a to low conversion efficiency for VUV radiation or the non-optimal interaction with the discharge. The white body color of these materials is desirable for fluorescent lamps, but in emissive displays, phosphors with a body color equal or similar to the emission color are wanted in order to enhance the daylight contrast.

Therefore, a substantial demand for novel or improved VUV phosphors as red converters still exists. Hence, it is an aspect of the invention to provide an alternative luminescent material, and an alternative lighting unit comprising such luminescent material, which preferably further at least partly obviate one or more of above-described drawbacks.

Surprisingly, it has been found that a trivalent praseodymium (Pr³⁺) doped rare earth in specific lattices, wherein Pr³⁺ substitutes for a tetravalent cations, such as Zr⁴⁺ or Hf⁴⁺, in combination with specific charge compensation, shows an intense and efficient red line emission, peaking at about 621 nm. Such trivalent praseodymium based luminescent materials may show luminescence in the red but may also have a non-white body color. An advantage of the application of a red line-emitting phosphor with a yellow to orange body colour for the red pixel in an emissive display is the enhanced contrast of the respective panel. An advantage of such a red line-emitting phosphor in a gas discharge lamp is the enhanced lumen equivalent and better colour point stability.

Further, it surprisingly appears that the luminescent material has a relative higher lumen equivalent (compared to Eu³⁺ based luminescent materials). Further, it surprisingly appears that the proposed systems have a better color point stability and a high quenching temperature (and may thus be applied over a large temperature range). Also the decay time is much shorter than for trivalent Europium.

Hence, in a first aspect, the invention provides a lighting unit comprising (1) a (vacuum ultraviolet (VUV) radiation based) source of radiation (“radiation source” or “VUV source”) configured to generate VUV radiation and (2) a luminescent material configured to convert at least part of the VUV radiation into visible luminescent material light, wherein the luminescent material comprises a trivalent praseodymium containing material selected from the group consisting of (Zr_{1-x-y}HfₓPr_{y})(Si_{1-y}P_{y})O₄, (Zr_{1-y-z}HfₓPr_{y})₃((Pr_{1-3/4y}S_{3/4y})O₄)₄, and (Zr_{1-x-y}HfₓPr_{y})₃((B_{1-3/4y}S_{3/4y}))O₃)₄, with x in the range of 0.01-1.0, y being larger than 0 and being equal to or smaller than 0.15 and 1−x−y>=0. In a further aspect, the invention provides a trivalent praseodymium containing material (per se) selected from the group consisting of (Zr_{1-x-y}HfₓPr_{y})(Si_{1-y}P_{y})O₄, (Zr_{1-x-y}HfₓPr_{y})₃((P_{1-3/4y}S_{3/4y})O₄)₄, and (Zr_{1-x-y}HfₓPr_{y})₃((B_{1-3/4y}S_{3/4y}))O₃)₄, with x=0.0-1.0, y being larger than 0 and being equal to or smaller than 0.15 and 1−x−y>0. These materials are herein also indicated as “red luminescent materials” or as “praseodymium containing material”.

Those luminescent materials may be used as efficient red light luminescent materials in PDP and DB applications, with a high lumen output and very good temperature stability. These trivalent praseodymium containing materials may efficiently absorb the VUV radiation generated in plasma display panels and dielectric barrier discharge lamps.

The luminescent material comprises at least one of the trivalent praseodymium containing materials defined herein, but may also comprise a combination of two or more of these trivalent praseodymium containing materials. Hence, in an embodiment, the term “trivalent praseodymium containing material” may also relate to a plurality of different trivalent praseodymium containing material. The term “different”, may in this context relate to different host lattices and/or different praseodymium contents, and/or the presence of optional co-activators. It may especially relate to different host lattices. It is noted that in principle a different ratio between for instance Zr/Hf already provides different host lattices.

Optionally, in addition to one or more of the trivalent praseodymium containing materials, the luminescent material may also comprise one or more other phosphors (luminescent materials) that may luminesce (i.e. emit) in the visible (upon excitation with the radiation of the source of radiation).

The trivalent praseodymium containing materials contain as cations that may partially be replaced by trivalent praseodymium the cations Zr⁴⁺ (tetravalent zirconium) and/or Hf⁴⁺ (tetravalent hafnium). Further, the trivalent praseodymium containing material belongs to the class of silicates, phosphates or borates.

Trivalent praseodymium is introduced in the host lattice of the trivalent praseodymium containing material, as can be derived from the efficient red emission at the expected spectral position (4f-4f transitions; mainly ¹D₂→³H₄). Characteristic is also the single sharp maximum at about 621 nm, which hardly shifts with temperature, and which dominates the spectrum nearly up to 500 K. This single sharp peak is also proof of the fact that Pr³⁺ substantially occupies one type of lattice positions (i.e. Zr⁴⁺), and the coordination by the Si/P—O-group, the P/S—O-group or the B/S—O group, respectively.

As part of the total amount of tetravalent cations is replaced by trivalent praseodymium, charge compensation is proposed. This charge compensation is performed by building in the silicate, borate or phosphate group an anion that can compensate the charge deficiency by the partial replacement of a tetravalent cation by a trivalent cation. This is done by introducing Pr³⁺ in combination with phosphor in the case of a silicate group or by introducing Pr³⁺ in combination with sulfur in the case of a phosphate or borate group. As phosphor or sulfur can thus also be seen as a dopant, (Zr_{1-x-y}HfₓPr_{y})(Si_{1-y}P_{y})O₄, for instance, may also be written as (Zr₁₋ₓHfₓ)SiO₄:Pr,P. Likewise, (Zr_{1-x-y}HfₓPr_{y})₃((P_{1-3/4y}S_{3/4y})O₄)₄ may be written as (Zr₁₋ₓHfₓ)₃PO₄)₄:Pr,S, etc.

However, some, such as about 0.1 to 10% of the praseodymium may (still) be present in the luminescent material (in its crystal lattice, i.e. in the host lattice) as tetravalent praseodymium, as can be derived from the body color. In an embodiment, undercompensation, such as non-compensation of the charge of 1-10% of the total amount of moles Pr may be used to create or enhance the body color. For instance, when the cation is replaced with y Pr³⁺, the anion may be replaced with 0.9-0.99 y. This may force some praseodymium in the tetravalent state.

Without charge compensation, the materials may have inferior luminescence characteristics, in view of low quantum efficiency, and may substantially be useless for temperature measurements (see below for the temperature measurements).

As indicated above, the luminescent material may be applied in for instance a plasma display panel or in a dielectric barrier discharge lamp (also indicated as dielectric barrier (DB) (noble gas excimer) discharge lamp).

Hence, the invention also provides the use of the trivalent praseodymium containing material selected from the group consisting of (Zr_{1-x-y}HfₓPr_{y})(Si_{1-y}P_{y})O₄, (Zr_{1-x-y}HfₓPr_{y})₃((P_{1-3/4y}S_{3/4y})O₄)₄, and (Zr_{1-x-y}HfₓPr_{y})₃((B_{1-3/4y}S_{3/4y}))O₃)₄, with x=0.0-1.0, y being larger than 0 and being equal to or smaller than 0.15 and 1−x−y>=0, as red luminescent material in a plasma display panel. Likewise, the invention also provides in a further aspect the lighting unit as defined above, wherein the lighting unit is a plasma display panel. As indicated above, the luminescent material based on the trivalent praseodymium containing material defined herein may especially be used to enhance daylight contrast.

In a further aspect, the invention provides the use of the trivalent praseodymium containing material selected from the group consisting of (Zr_{1-x-y}HfₓPr_{y})(Si_{1-y}P_{y})O₄, (Zr_{1-x-y}HfₓPr_{y})₃((P_{1-3/4y}S_{3/4y})O₄)₄, and (Zr_{1-x-y}HfₓPr_{y})₃((B_{1-3/4y}S_{3/4y}))O₃)₄, with x=0.0-1.0, y being larger than 0 and being equal to or smaller than 0.15 and 1−x−y>=0, as red luminescent material in a dielectric barrier (DB) discharge lamp comprising a discharge vessel containing the luminescent material. Likewise, the invention also provides in a further aspect the lighting unit as defined above, wherein the lighting unit is a dielectric barrier (DB) discharge lamp comprising a discharge vessel containing the luminescent material.

As indicated above, the trivalent praseodymium containing material has high temperature stability and a high quenching temperature. This allows a specific use of the luminescent material, viz. as temperature sensor. It appears that the quench temperature is high, thus with increasing temperature, the efficiency is not substantially affected up to a temperature of about 500 K. Further, the color point hardly varies with increasing temperature. Hence, the optical properties are excellent for DB applications. With increasing temperature, phone side bands (clearly) appear and the line width of the 4f-4f transitions broaden (slightly). Those spectral features may be used to determine the temperature of the luminescent material (more precisely, the trivalent praseodymium containing material), and thereby give a good indication of the temperature within the discharge vessel. Hence, the invention also provides the use of the luminescence of a trivalent praseodymium containing material selected from the group consisting of (Zr_{1-x-y}HfₓPr_{y})(Si_{1-y}P_{y})O₄, (Zr_{1-x-y}HfₓPr_{y})₃((P_{1-3/4y}S_{3/4y})O₄)₄, and (Zr_{1-x-y}HfₓPr_{y})₃((B_{1-3/4y}S_{3/4y}))O₃)₄, with x=0.0-1.0, y being larger than 0 and being equal to or smaller than 0.15 and 1−x−y>=0, for in situ temperature measurement of the temperature in a discharge vessel (of a DB discharge lamp). Likewise, the invention also provides a lighting unit as defined above, further comprising an optical sensor configured to measure the luminescent material light in at least part of the wavelength range of 550-700 nm and configured to generate a corresponding sensor signal, and a control unit, configured to determine from the sensor signal the temperature within the discharge vessel. The control unit may further be configured to control the temperature within discharge vessel based on a predetermined value.

Use of the temperature sensor function of the luminescent material may of course be combined with the inherent function of the trivalent praseodymium containing material in the DB discharge lamp. However, without charge compensation as defined herein, the spectra appear to be too blurred to obtain a sensible signal for temperature analysis.

The discharge vessel may be any type of discharge vessel. However, in a specific embodiment it is a discharge vessel suitable for a dielectric barrier (DB) excimer discharge type lamp. An example of a dielectric barrier (DB) excimer discharge that can be used in such lamp is the Xe excimer discharge, which e.g. emits mainly 172 nm radiation. DB driven quartz lamps comprising Xe as a filling gas show a wall plug efficiency of more than 30%. A quartz lamp based on a Xe excimer discharge was developed by Ushio and Heraeus and is used for the cleaning of wafer surfaces due to the sufficiently high energy of the emitted 172 nm (VUV) photons to cleave any type of organic bonds. Other emission wavelengths were achieved by using a XeBr* (282 nm), XeCl (308 nm), or KrCl* (222 nm) excimers, however, this goes at the cost of discharge efficiency. Hence, the (excimer) discharge lamp or gas discharge panel (i.e. PDP) may comprise a discharge vessel which is filled with one or more of Ar, Kr, Xe, F₂, Cl₂, Br₂, I₂, especially at least Xe. At least part of the inner surface of the discharge vessel may be coated. The radiation source may especially be configured to provide radiation at least in the range of 150-180 nm, even more especially in at least the range of 165-175 nm. VUV radiation is considered to be in the range of 10-200 nm, such as 100-200 nm.

Further, the (excimer) discharge lamp or gas discharge panel may thus comprise a discharge vessel, which is coated by the luminescent material as defined herein. For instance, a coating may be applied containg said luminescent material. The coating (to be applied) may further contain usual components like a liquid, a binder and optionally scattering material, and optionally further luminescent materials. A substantial part of the liquid and the binder after application of the coating on at least part of the discharge vessel (wall) may be removed, which implies that the coating on the discharge vessel of the lighting unit in use may essentially consist of the trivalent praseodymium containing material, optional scattering material, and optional further luminescent material.

In a specific embodiment, wherein x is 0, i.e. the trivalent praseodymium containing material is selected from the group consisting of (Zr_{1-y}Pr_{y})(Si_{1-y}P_{y})O₄, (Zr_{1-y}Pr_{y})₃((P_{1-3/4y}S_{3/4}y)O₄)₄, and (Zr_{1-y}Pr_{y})₃((B_{1-3/4y}S_{3/4y}))O₃)₄, with y being larger than 0 and being equal to or smaller than 0.15.

In a specific embodiment, y is in the range of 0.005-0.1, especially in the range of 0.015-0.06 (i.e. 1.5-6% of the cations that can be replaced by trivalent praseodymium (i.e. Zr and Hf) are replaced by trivalent praseodymium. For instance, when x=0.5 and y=0.02, and assuming a silicate, the following formula is obtained: (Zr_{0.48}Hf_{0.5}Pr_{0.02})(Si_{0.98}P_{0.02})O₄, i.e. 2% of Zr+Hf is replaced by praseodymium. Note that also 2% can be replaced with x being 0.48 and y being 0.02 (i.e. (Zr_{0.5}Hf_{0.48}Pr_{0.02})(Si_{0.98}P_{0.02})O₄ is obtained) or with x being 0.49 and y being 0.02 (i.e. (Zr_{0.49}Hf_{0.49}Pr_{0.02})(Si_{0.98}P_{0.02})O₄ is obtained). In a specific embodiment, the luminescent material at least comprises (Zr_{1-x-y}HfₓPr_{y})(Si_{1-y}P_{y})O₄.

As indicated above, x may be in the range of 0-1, for example x>0, x<1, or 0<x<1; in an embodiment, x is in the range of 0-0.2. In yet another embodiment, x is in the range of 0.8-1.0.

In a specific embodiment, the luminescent material is a particulate luminescent material and the particles of the luminescent material, i.e. especially the trivalent praseodymium containing material particles, comprise a coating comprising one or more materials selected from the group consisting of Al₂O₃ (α, γ, Θ, or δ-phase), LnPO₄ (Ln=La, Y, Lu), SiO₂, Al₂SiO₅, Mg₂SiO₄, (Ca,Sr,Ba)-polyphosphat, (Mg,Ca)₂P₂O₇, and ZrO₂. The coating encloses the trivalent praseodymium containing material as indicated above.

The term white light herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL (black body locus), especially within about 10 SDCM from the BBL, even more especially within about 5 SDCM from the BBL.

The terms “violet light” or “violet emission” especially relates to light having a wavelength in the range of about 380-440 nm. The terms “blue light” or “blue emission” especially relates to light having a wavelength in the range of about 440-490 nm (including some violet and cyan hues). The terms “green light” or “green emission” especially relate to light having a wavelength in the range of about 490-560 nm. The terms “yellow light” or “yellow emission” especially relate to light having a wavelength in the range of about 560-590 nm. The terms “orange light” or “orange emission” especially relate to light having a wavelength in the range of about 590-620. The terms “red light” or “red emission” especially relate to light having a wavelength in the range of about 620-750 nm. The terms “visible” light or “visible emission” refer to light having a wavelength in the range of about 380-750 nm.

The terms “upstream” and “downstream” relate to an arrangement of items or features relative to the propagation of the light from a light generating means, wherein relative to a first position within a beam of light from the light generating means, a second position in the beam of light closer to the light generating means is “upstream”, and a third position within the beam of light further away from the light generating means is “downstream”.

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts an embodiment of the lighting unit;

FIGS. 2a-2c schematically depict some embodiments and variants of the lighting unit and the luminescent material.

The drawings are not necessarily on scale.

FIGS. 3a-3c show some measurement results on a the trivalent praseodymium containing material.

### DETAILED DESCRIPTION OF THE EMBODIMENTS

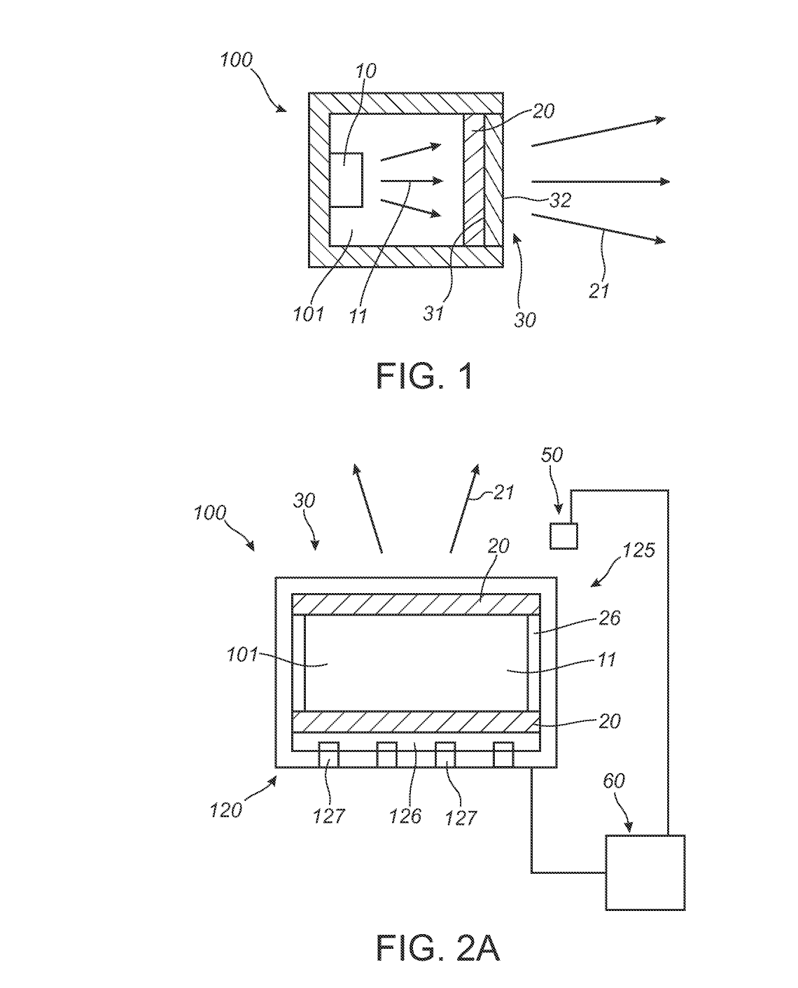

FIG. 1 schematically depicts a lighting unit 100 comprising a radiation source 10 configured to provide radiation 11, further also indicated as VUV radiation 11. The lighting unit 100 further comprises a window 30, with an upstream face 31 and a downstream face 32. This window 30 is transmissive for visible light of the luminescent material, which is indicated with reference 20. In this embodiment, by way of example, the luminescent material 20 is present as coating to the upstream face 31. Luminescent material light (“luminescence”) is indicated with reference 21. This luminescence may contain contributions of the red luminescent material as described herein, but may optionally also contain contribution of other types of phosphors/luminescent materials, such as BaMgAl₁₀O₁₇:Eu²⁺, Sr₂Al₆O₁₁:Eu²⁺, GdMgB₅O₁₀:Ce³⁺Tb³⁺, YBO₃:Ce³⁺Tb³⁺, Zn₂SiO₄:Mn²⁺, BaMgAl₁₀O₁₇:Mn²⁺, (Y,Gd)BO₃:Eu³⁺, etc. The interior of the lighting unit 100 is indicated with reference 101. For instance, this may be a light mixing chamber. The interior is enclosed by a wall, of which part may be window 30.

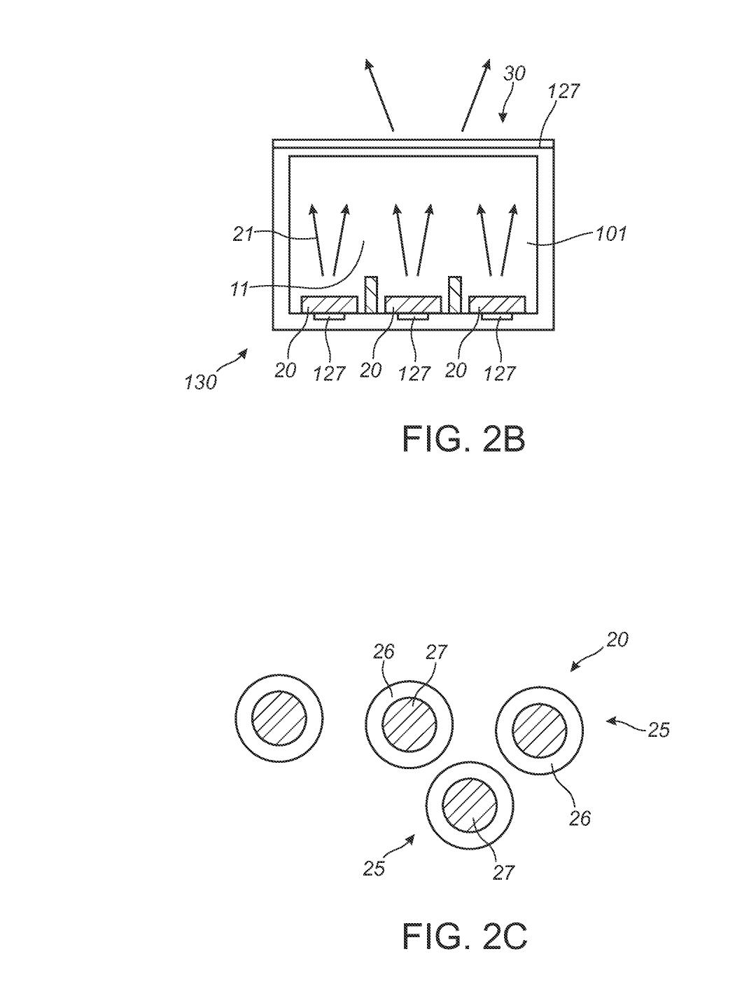

FIGS. 2a and 2b very schematically depict a dielectric barrier discharge lamp 120 and a plasma display panel unit 130. Commonly known side apparatus, elements, ballasts, etc., such as a source of electrical power, electrical wiring, etc. are not depicted in the drawings (for the sake of understanding).

The DB discharge lamp 120, see FIG. 2a, comprises discharge vessel 125. Within the discharge vessel, i.e. in interior 101, radiation 11 is generated due to the creation of discharge(s). To this end, the DB discharge lamp 120 further comprise (DB) electrodes 127. References 26 and 126 refer to (optional) reflective layers. The lower reflective layer 126 may be a barrier or may be part of a barrier. By way of example, the luminescent material 20 is arranged at the upstream side of the window 30 and also at the reflective layer 126 over the electrodes 127.

Optionally, the lighting unit 100 may comprise an optical sensor 50, which may be configured to measure the red luminescence of the praseodymium containing material(s) comprised in the luminescent material 20, as from the spectrum of the praseodymium containing material the temperature of the material (and thus also of the interior 101) may be derived. The sensor 50 may functionally be coupled to a control unit 60, which may derive the temperature of the praseodymium containing material from the sensor signal generated by sensor 50. Optionally, control unit 60 may control the temperature (i.e. control the discharge), based on the sensor signal and a predetermined (preset) temperature.

FIG. 2b very schematically depicts a PDP unit 130. The compartments with luminescent material 20 may for instance contain RGB luminescent material. The red component may be the praseodymium containing material as defined herein. The window 30 may comprise a transparent electrode; the electrodes are again indicated with references 127.

FIG. 2c schematically depicts a coated luminescent material 20. Here, the luminescent material comprises particles 25. The particles 25 may be provided with a coating 26. The active material/phosphor within the particles 25, i.e. the praseodymium containing material as defined herein, within the core, is indicated with reference 27.

### Experimental

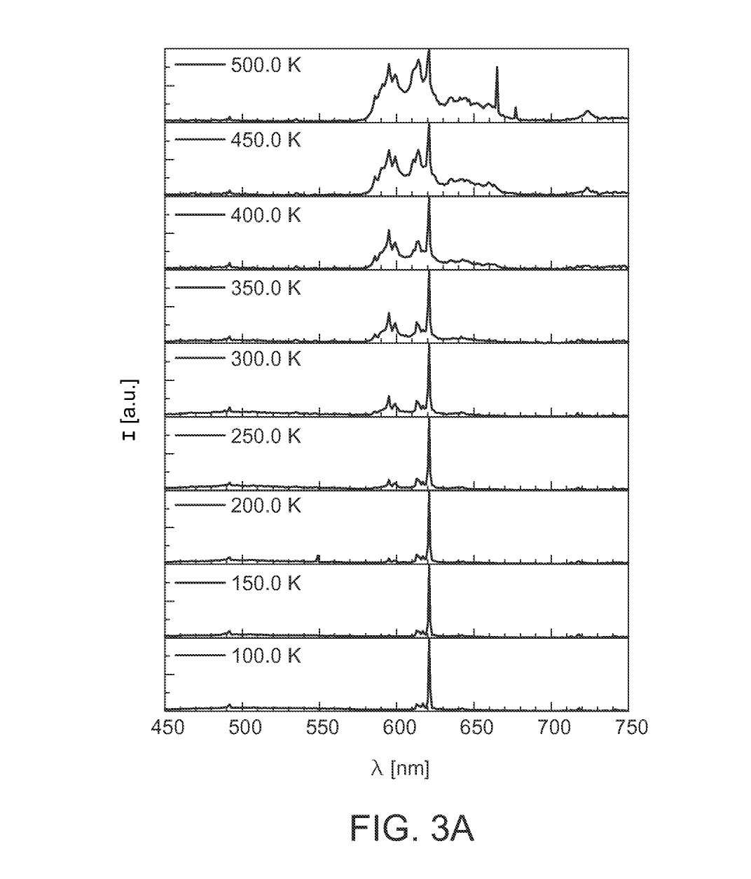

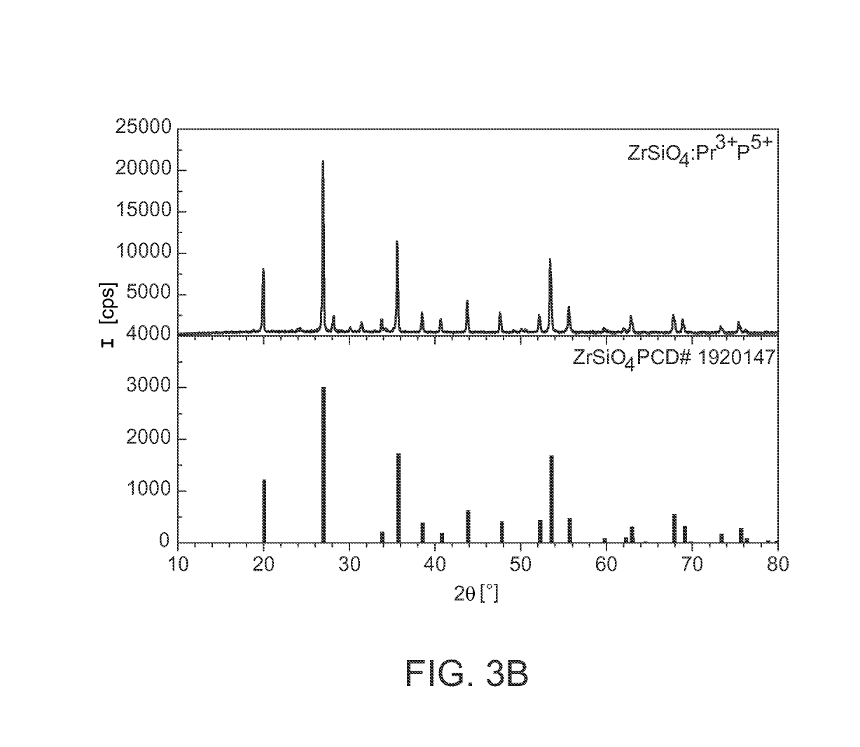

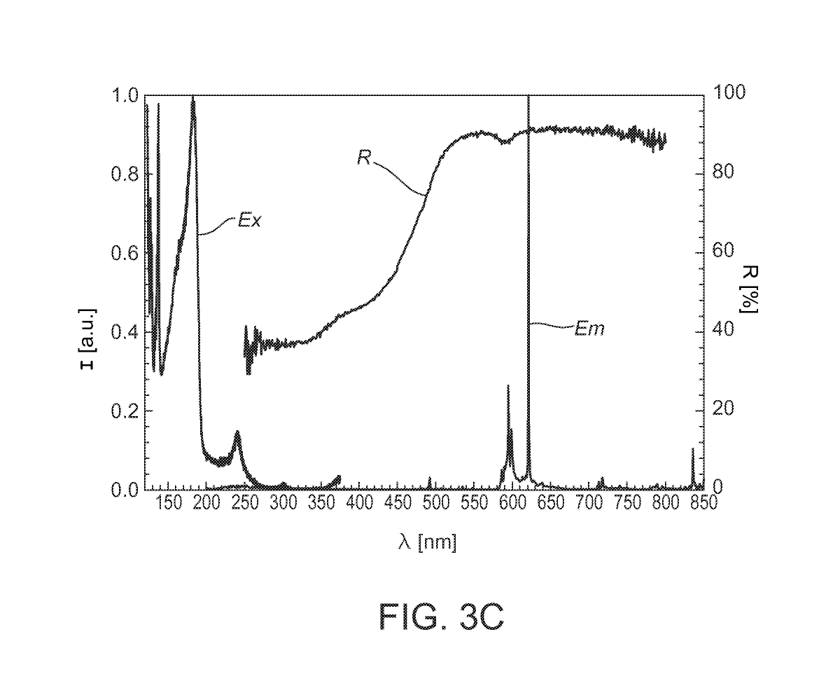

FIG. 3a shows the luminescence spectra of ZrSiO₄:Pr,P as a function of temperature (y-axis: normalized intensity in arbitrary units; x-axis wavelength in nanometers). The strong temperature dependence of the emission pattern located in the red spectral range enables the material to be used as a temperature sensor too. At the same time the colour point hardly shifts between 100 and 500 K, since the centroid wavelength of the spectrum remains almost constant. The shift in x and y from 100 K to 500 K is within 0.05 (for both x and y in the CIE 1931 color diagram). The color point at 293 K is x=0.643 and y=0.355.

Decay measurements for the red luminescence gave a τ₁ of 53.68 μs (15.15%) and a τ₂ of 216.7 μs (84.85%) (with a χ² of 1.276) (1/e curves). The decay time is substantially shorter than for the red emission of trivalent Europioum, which is advantageous in view of PDP applications.

### Preparation of ZrSiO₄:PR (1%), P (1%)

The starting materials 1.000 g SiO₂, 2.051 g ZrO₂, 0.0286 g Pr₆O₁₁, and 0.0639 g Na₃PO₄.12H₂O are thoroughly blended in an agate mortar. Then 0.309 g LiSO₄.H₂O is added to these starting materials and the intimately ground precursor blend is filled into a corundum crucible and covered by a lid. In a first annealing step, the material is treated for 5 h at 900° C. under CO. In a second annealing step the material is treated for 5 h at 1200° C. under CO. Finally, the powder cake is crushed by milling and the powder is sieved to remove any agglomerates.

XRD data are shown in FIG. 3b (y axis intensity in cps; x axis angle 2 θ). FIG. 3c depicts the excitation (EX; normalized intensity in arbitrary units), luminescence or emission (EM; normalized intensity in arbitrary units) and reflectance (R; %) of the material as function of the wavelength (nm)

### Preparation of Zr₃(PO₄)₄:Pr (1%), S (1%)

The starting materials 2.300 g NH₄H₂PO₄, 1.844 g ZrO₂, 0.028 g Pr₆O₁₁, and 0.020 g (NH₄)₂SO₄ are thoroughly blended in an agate mortar. Then 0.180 g Li₂SO₄.H₂O is added to these starting materials and the intimately ground precursor blend is filled into a corundum crucible and covered by a lid. In a first annealing step, the material is treated for 5 h at 900° C. under CO. In a second annealing step the material is treated for 5 h at 1200° C. under CO. Finally, the powder cake is crushed by milling and the powder is sieved to remove any agglomerates.

### Preparation of Zr₃(BO₃)₄:Pr (1%), S (1%)

The starting materials 1.372 g H₃BO₃, 2.046 g ZrO₂, 0.0290 g Pr₆O₁₁, and 0.010 g SiO₄ are thoroughly blended in an agate mortar. Then 0.140 g Li₂SO₄.H₂O is added to these starting materials and the intimately ground precursor blend is filled into a corundum crucible and covered by a lid. In a first annealing step, the material is treated for 5 h at 900° C. under CO. In a second annealing step the material is treated for 5 h at 1200° C. under CO. Finally, the powder cake is crushed by milling and the powder is sieved to remove any agglomerates.

1. A lighting unit comprising (1) a vacuum ultraviolet (VUV) radiation based source of radiation configured to generate VUV radiation, and (2) a luminescent material configured to convert at least part of the VUV radiation into visible luminescent material light, wherein the luminescent material comprises a trivalent praseodymium containing material selected from the group consisting of (Zr_{1-x-y}HfₓPr_{y})(Si_{1-y}P_{y})O₄, (Zr_{1-x-y}HfₓPr_{y})₃((P_{1-3/4y}S_{3/4y})O₄)₄, and (Zr_{1-x-y}HfₓPr_{y})₃((B_{1-3/4y}S_{3/4y}))O₃)₄, with x in the range of 0.0-1.0, y being larger than 0 and being equal to or smaller than 0.15 and 1−x−y>=0.

2. The lighting unit according to claim 1, wherein x is 0 and wherein y is in the range of 0.01-0.1.

3. The lighting unit according to claim 1, wherein the luminescent material at least comprises (Zr_{1-x-y}HfₓPr_{y})(Si_{1-y}P_{y})O₄.

4. The lighting unit according to claim 1, wherein the lighting unit (100) is a plasma display panel.

5. The lighting unit according to claim 1, wherein the lighting unit is a dielectric barrier (DB) discharge lamp comprising a discharge vessel containing the luminescent material.

6. The lighting unit according to claim 5, further comprising an optical sensor configured to measure the luminescent material light in at least part of the wavelength range of 550-700 nm and configured to generate a corresponding sensor signal, and a control unit, configured to determine from the sensor signal the temperature within the discharge vessel and control the temperature within discharge vessel based on a predetermined value.

7. The lighting unit according to claim 1, wherein the radiation source is configured to provide radiation at least in the range of 150-180 nm.

8. The lighting unit according to claim 1, wherein the luminescent material is a particulate luminescent material and wherein the particles of the luminescent material comprise a coating comprising one or more materials selected from the group consisting of Al₂O₃ (α, γ, Θ, or δ-phase), LnPO₄ (Ln=La, Y, Lu), SiO₂, Al₂SiO₅, Mg₂SiO₄, (Ca,Sr,Ba)-polyphosphat, (Mg,Ca)₂P₂O₇, and ZrO₂.

9. Use of the luminescence of a trivalent praseodymium containing material selected from the group consisting of (Zr_{1-x-y}HfₓPr_{y})(Si_{1-y}P_{y})O₄, (Zr_{1-x-y}HfₓPr_{y})₃((P_{1-3/4y}S_{3/4}y)O₄)₄, and Zr_{1-x-y}HfₓPr_{y})₃((B_{1-3/4y}S_{3/4y})O₃)₄, with x=0.0-1.0, y being larger than 0 and being equal to or smaller than 0.15 and 1−x−y>=0, for in situ temperature measurement of the temperature in a discharge vessel.

10. An optical sensor comprising a trivalent praseodymium containing material selected from the group consisting of (Zr_{1-x-y}HfₓPr_{y})(Si_{1-y}P_{y})O₄, (Zr_{1-x-y}HfₓPr_{y})₃((P_{1-3/4y}S_{3/4y})O₄)₄, and (Zr_{1-x-y}HfₓPr_{y})₃((B_{1-3/4y}S_{3/4y})O₃)₄, with x=0.01-1.0, y being larger than 0 and being equal to or smaller than 0.15 and 1−x−y>=0, said sensor being configured to measure the luminescent material light in at least part of the wavelength range of 550-700 nm and configured to generate a corresponding sensor signal.

11. Use of a trivalent praseodymium containing material selected from the group consisting of (Zr_{1-x-y}HfₓPr_{y})(Si_{1-y}P_{y})O₄, (Zr_{1-x-y}HfₓPr_{y})₃((P_{1-3/4y}S_{3/4y})O₄)₄, and (Zn_{1-x-y}HfₓPr_{y})₃((B_{1-3/4y}S_{3/4y}))O₃)₄, with with x=0.0-1.0, y being larger than 0 and being equal to or smaller than 0.15 and 1−x−y>=0, as red luminescent material in a plasma display panel.

12. Use of a trivalent praseodymium containing material selected from the group consisting of (Zr_{1-x-y}HfₓPr_{y})(Si_{1-y}P_{y})O₄, (Zr_{1-x-y}HfₓPr_{y})₃((P_{1-3/4y}S_{3/4y})O₄)₄, and (Zr_{1-x-y}HfₓPr_{y})₃((B_{1-3/4y}S_{3/4y}))O₃)₄, with x=0.0-1.0, y being larger than 0 and being equal to or smaller than 0.15 and 1−x−y>=0, as red luminescent material in a dielectric barrier (DB) discharge lamp comprising a discharge vessel containing the luminescent material.

13. A trivalent praseodymium containing material selected from the group consisting of (Zr_{1-x-y}HfₓPr_{y})(Si_{1-y}P_{y})O₄, (Zr_{1-x-y}HfₓPry_{y})₃((P_{1-3/4y}S_{3/4y})O₄)₄, and (Zr_{1-x-y}HfₓPr_{y})₃((B_{1-3/4y}S_{3/4y}))O₃)₄, with x=0.01-1.0, y being larger than 0 and being equal to or smaller than 0.15 and 1−x−y>=0.

14. The trivalent praseodymium containing material according to claim 13, wherein x is 0.

15. The trivalent praseodymium containing material according to claim 13, wherein y is in the range of 0.01-0.1.
